(19) United States
(12) Patent Application Publication
(10) Pub. No.: US 2011/0314877 A1
(43) Pub. Date: Dec. 29, 2011

(54) Locking Assembly for a Door

(76) Inventor: Guan-Chen FANG, Tianjin (CN)

(21) Appl. No.: 12/825,491

(22) Filed: Jun. 29, 2010

(51) Int. Cl. E05B 65/00

(52) U.S. Cl. 70/91

(57) ABSTRACT

A locking assembly for a door having an outer side, an inner side and a sidewall and has an exterior assembly, a latch and an interior assembly. The exterior assembly is securely mounted on the outer side of the door and has a mounting seat, a press-button, a transmitting device, a transmitting board, a hooking wheel, an engaging wheel, a rotating spindle and a driving shaft. The latch is securely mounted in the sidewall of the door, is connected to the exterior assembly and has a mounting end, a locking end, a latch bar and a rotating hole. The interior assembly is securely mounted on the inner side of the door, is connected to the exterior assembly and the latch and has an outer side, an inner side, a rotating mount, an inside reset spring, a driving square hole and a rotating button.

### BACKGROUND OF THE INVENTION

1. Field of the Invention

The present invention relates to a locking assembly, and more particularly relates to a locking assembly for a door that has a prolonged useful life and can be assembled conveniently.

2. Description of Related Art

A conventional locking assembly is securely mounted on a door to lock the door to prevent unauthorized access to a room. The conventional locking assembly usually has an exterior assembly, a latch and an interior assembly. The exterior assembly and the interior assembly are respectively mounted on opposite sides of the door and the latch is mounted on a sidewall of the door between the exterior assembly and the interior assembly. The exterior assembly has a press-button, a rotating spindle extended through the latch and connected to the interior assembly and an outside reset spring mounted in the exterior assembly. The rotating spindle can be rotated by a gear wheel or a cam. The interior assembly has an inner reset spring mounted in the interior assembly to press the rotating spindle of the exterior assembly.

When a user presses the press-button of the exterior assembly, the rotating spindle will rotate to move the latch to unlock the door and press the reset spring in the interior assembly at the same time. The reset springs are compressed at the same time by the rotating spindle when pressing the press-button and this will increase a force required to press the press-button and shorten the life of the reset spring.

Furthermore, another conventional locking assembly has an exterior assembly, a latch and an interior assembly, and each knob has a rotating spindle inserted into the latch. Thus, each knob can unlock the door with the rotating spindle of the knob, and this can avoid the interference between the knobs when unlocking the door. However, when the conventional locking assembly is applied onto a door with a different thickness, the rotating spindles of the knobs may not be inserted into the latch at the same time. Therefore, changing two new rotating spindles may be necessary and the conventional locking assembly is inconvenient to assemble.

The invention provides a locking assembly that mitigates or obviates the aforementioned problems.

### SUMMARY OF THE INVENTION

The main objective of the present invention is to provide a locking assembly for a door that can be extended the life of the locking assembly and can be assembled conveniently.

The locking assembly for a door having an outer side, an inner side and a sidewall in accordance with the present invention has an exterior assembly, a latch and an interior assembly. The exterior assembly is securely mounted on the outer side of the door and has a mounting seat, a press-button, a transmitting device, a transmitting board, a hooking wheel, an engaging wheel, a rotating spindle and a driving shaft. The latch is securely mounted in the sidewall of the door, is connected to the exterior assembly and has a mounting end, a locking end, a latch bar and a rotating hole. The interior assembly is securely mounted on the inner side of the door, is connected to the exterior assembly and the latch and has an outer side, an inner side, a rotating mount, an inside reset spring, a driving square hole and a rotating button.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a locking assembly for a door in accordance with the present invention;

FIG. 2 is a perspective view of an exterior assembly of the locking assembly in FIG. 1;

FIG. 3A is an enlarged exploded perspective view of the exterior assembly in FIG. 2;

FIG. 3B is an enlarged perspective view of an engaging wheel of the exterior assembly in FIG. 3A;

FIG. 3C is an enlarged perspective view of a driving shaft of the exterior assembly in FIG. 3A;

FIG. 4 is an enlarged side view in partial section of the exterior assembly in FIG. 2;

FIG. 5 is another enlarged side view in partial section of the exterior assembly in FIG. 2

FIGS. 6 and 7 are operational side views in partial section of the exterior assembly in FIG. 5;

FIG. 8 is an operational side view in partial section of the exterior assembly in FIG. 5 when the interior assembly is rotated in a clockwise direction; and

FIG. 9 is an operational side view in partial section of the exterior assembly in FIG. 5 when the interior assembly is rotated in a counterclockwise direction.

### DETAILED DESCRIPTION OF THE PREFERRED EMBODIMENT

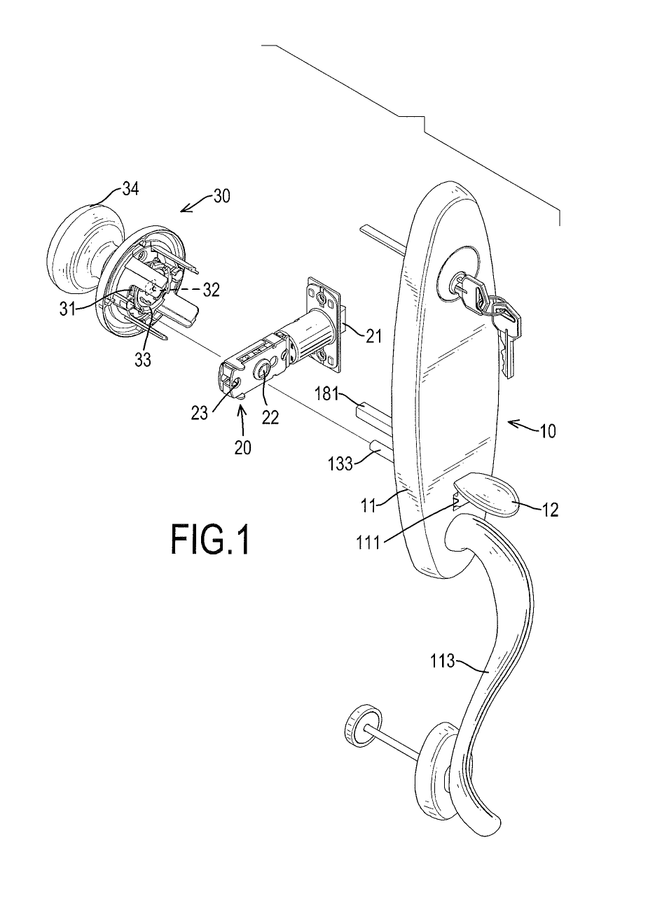

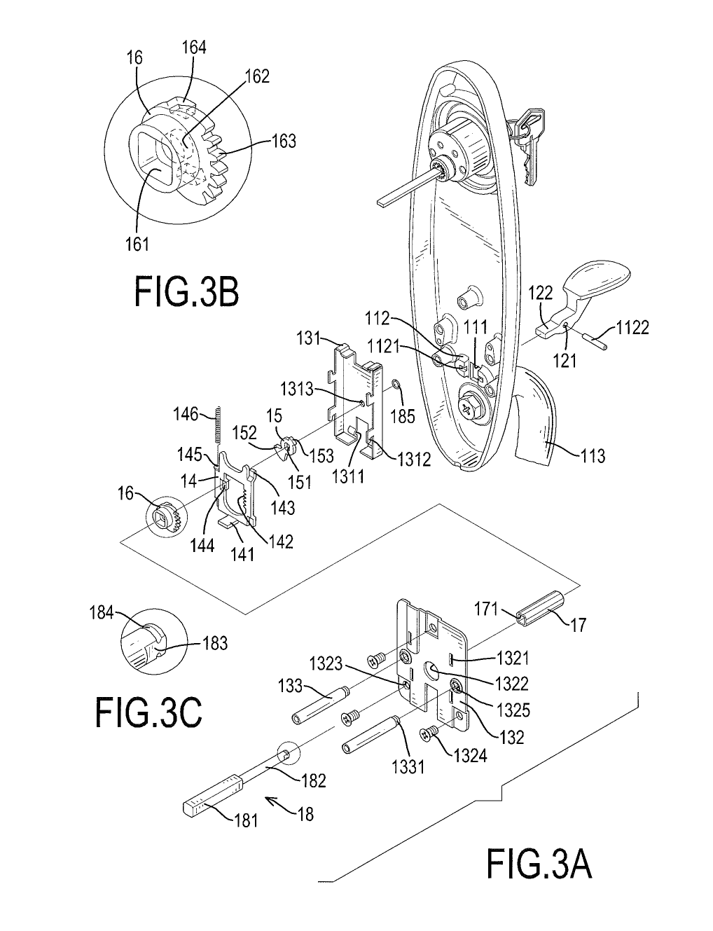

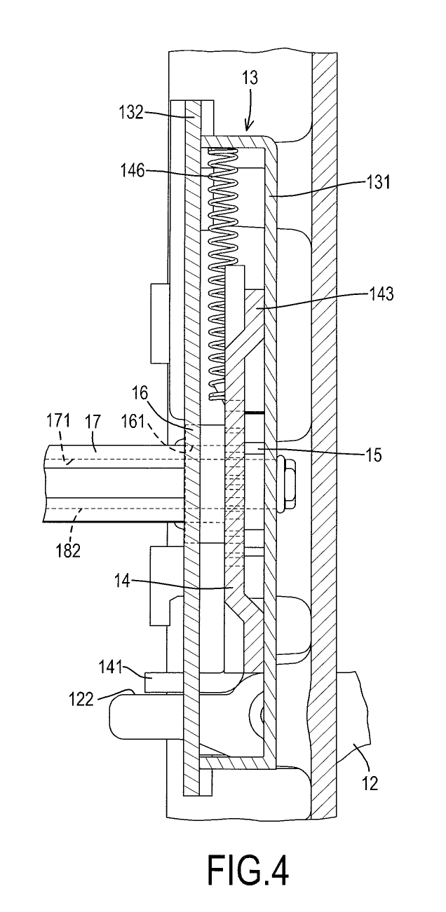

With reference to FIGS. 1 to 4, a locking assembly in accordance with the present invention is mounted on a door having an outer side, an inner side and a sidewall and comprises an exterior assembly (10), a latch (20) and an interior assembly (30).

The exterior assembly (10) is securely mounted on the outer side of the door and has a mounting seat (11), a press-button (12), a transmitting device (13), a transmitting board (14), a hooking wheel (15), an engaging wheel (16), a rotating spindle (17) and a driving shaft (18).

The mounting seat (11) is securely mounted on the outer side of the door and has an outer side, an inner side, an upper end, a lower end, a handle (113), a mounting hole (111), two mounting bases (112) and a mounting pin (1122). The inner side of the mounting seat (11) abuts with the outer side of the door. The handle (113) is mounted on the outer side of the mounting seat (11) near the lower end. The mounting hole (111) is square and is formed through the mounting seat (11) near the handle (113). The mounting bases (112) are formed on and protrude from the inner side of the mounting seat (11) beside the mounting hole (111) and each mounting base (112) has a mounting recess (1121) facing the mounting hole (111). The mounting pin (1122) is mounted in the mounting recesses (1121) of the mounting bases (112).

The press-button (12) is pivotally connected to the mounting seat (11) in the mounting hole (111) and has an inner end, an outer end, a top side, a pin hole (121) and a driving surface (122). The inner end of the press-button (12) is inserted in the mounting hole (111) and extends out of the inner side of the mounting seat (11). The pin hole (121) is formed through the press-button (12) near the inner end and is mounted around the mounting pin (1122) of the mounting seat (11). The driving surface (122) is defined on the top side of the press-button (12) at the inner end.

The transmitting device (13) is mounted on the inner side of the mounting seat (11) and has a transmitting casing (131), a covering panel (132) and two supporting rods (133).

The transmitting casing (131) is rectangular, is mounted on the inner side of the mounting seat (11) and has a closed outer side, an open inner side, a top, a bottom, two opposite sidewalls, a width, a button through hole (1311), multiple holding claws (1312) and an outer shaft hole (1313). The closed outer side of the transmitting casing (131) is mounted on the inner side of the mounting seat (11), covers the mounting recesses (1121) of the mounting seat (11) to hold the mounting pin (1122) between the mounting bases (112) and the transmitting casing (131). The button through hole (1311) is formed through the closed outer side and the bottom of the transmitting casing (131) and aligns with the mounting hole (111). The inner end of the press-button (12) extends out of the button through hole (1311) of the transmitting casing (131). The holding claws (1312) are respectively formed on and protrude from the opposite sidewalls of the transmitting casing (131) around the open inner side. The outer shaft hole (1313) is formed through the closed outer side of the transmitting casing (131) above the button through hole (1311) and has a diameter.

The covering panel (132) is detachably connected to the transmitting casing (131) to cover the open inner side of the transmitting casing (131) and has a width, a top, a bottom, multiple holding holes (1321), an inner shaft hole (1322), multiple fastener holes (1323), multiple fasteners (1324) and two positioning holes (1325). The width of the covering panel (132) is larger than the width of the transmitting casing (131). The inner end of the press-button (12) extends out the bottom of the covering panel (132). The holding holes (1321) are formed through the covering panel (132) and are respectively connected to the holding claws (1312) to hold the covering panel (132) securely with the transmitting casing (131). The inner shaft hole (1322) is formed through the covering panel (132), aligns with the outer shaft hole (1313) of the transmitting casing (131) and has a diameter larger than the diameter of the outer shaft hole (1313). The fastener holes (1323) are formed through the covering panel (132) near the top and the bottom. The fasteners (1324) are mounted through the fastener holes (1323) and are connected securely to the inner side of the mounting seat (11). The positioning holes (1325) are formed through the covering panel (132) beside the inner shaft hole (1322).

The supporting rods (133) are connected to the covering panel (132) and each supporting rod (133) has a diameter, an outer end, an inner end and a positioning pin (1331). The positioning pins (133) are respectively formed on and protrude from the outer ends of the supporting rods (133), are respectively mounted in the positioning holes (1325) of the covering panel (132) and each positioning pin (133) has a diameter smaller than the diameter of the supporting rod (133).

The transmitting board (14) is mounted in the transmitting device (13) between the transmitting casing (131) and the covering panel (132) and has a top, a bottom, a middle, two sides, an abutting slab (141), a rack (142), two positioning blocks (143), a transmitting block (144), a spring mount (145) and an outer reset spring (146). The abutting slab (141) is formed on and protrudes from the bottom of the transmitting board (14), extends out of the bottom of the covering panel (132) and abuts with the driving surface (122) of the press-button (12). The rack (142) is formed in the transmitting board (14) near the middle and is parallel with the opposite sidewalls of the transmitting casing (131) near one of the sides of the transmitting board (14). The positioning blocks (143) are respectively formed on and protrude from the top and the bottom of the transmitting board (14) on the side that is adjacent to the rack (14) and abut the closed outer side of the transmitting casing (131). The transmitting block (144) is formed on and protrudes from the middle of the transmitting board (14) near the other side that is opposite to the rack (142), abuts the closed outer side of the transmitting casing (131) and has a bottom face. The spring mount (145) is formed on the side of the transmitting board (14) that is adjacent to the transmitting block (144). The outside reset spring (146) is mounted between the transmitting casing (131) and the transmitting board (14) and has two ends. One of ends of the outside reset spring (146) abuts the top of the transmitting casing (131) and the other end of the outside reset spring (146) is mounted on the spring mount (145) of the transmitting board (14).

The hooking wheel (15) is circular, is rotatably mounted in the transmitting device (13) between the transmitting casing (131), the positioning blocks (143) and the transmitting block (144) of the transmitting board (14) and has a connecting hole (151), a pushing board (152) and a driven slab (153). The connecting hole (151) is formed through the hooking wheel (15) and aligns with the outer shaft hole (1313) of the transmitting casing (131). The pushing board (152) may be sectorial, is aslant formed on and protrudes from the hooking wheel (15) and abuts the bottom face of the transmitting block (144). The driven slab (153) is aslant formed on and protrudes from the hooking wheel (15) opposite to the pushing board (152).

The engaging wheel (16) is rotatably mounted in the transmitting board (14) between the hooking wheel (15) and the covering panel (132), engages the rack (142) of the transmitting board (14) and has an inner side, an outer side, a periphery, a spindle hole (161), a circular hole (162), multiple engaging teeth (163) and two limiting blocks (164). The inner side of the engaging wheel (16) is mounted in the inner shaft hole (1322) of the covering panel (132). The outer side of the engaging wheel (16) is mounted in the transmitting board (14) between the rack (142) and the transmitting block (144). The spindle hole (161) is square, is formed in the inner side of the engaging wheel (16) and has a diameter. The circular hole (162) is formed in the outer side of the engaging wheel (16), communicates with the spindle hole (161) and aligns with the connecting hole (151) of the hooking wheel (15) and has a diameter smaller than the diameter of the spindle hole (161). The engaging teeth (163) are formed on the periphery of the engaging wheel (16) near the outer side and engages the rack (142) of the transmitting board (14). The limiting blocks (164) are formed on and protrude from the outer side of the engaging wheel (16) beside the driven slab (153) of the hooking wheel (15). The driven slab (153) of the hooking wheel (15) selectively abuts one of the limiting blocks (164).

The rotating spindle (17) is square, is connected to the engaging wheel (16) and has an outer end, an inner end and an internal hole (171). The outer end of the rotating spindle (17) is mounted in the spindle hole (161) of the engaging wheel (16). The inner end of the rotating spindle (17) extends out of the inner shaft hole (1322) of the covering panel (132). The internal hole (171) is formed through the ends of the rotating spindle (17) and corresponds to the circular hole (162) of the engaging wheel (16).

The driving shaft (18) is rotatably mounted in the rotating spindle (17), extends through the rotating spindle (17), the covering panel (132), the engaging wheel (16), the transmitting board (14) and the hooking wheel (15), is securely connected to the transmitting casing (131) and has an outer end, an inner end, a square bar segment (181), a circular bar segment (182), an engaging face (183), an annular groove (184) and a retaining ring (185).

The outer end of the driving shaft (18) extends through the rotating spindle (17), the covering panel (132), the engaging wheel (16), the transmitting board (14) and the hooking wheel (15) and is securely connected to the outer shaft hole (1313) of the transmitting casing (131). The inner end of the driving shaft (18) extends out of the inner end of the rotating spindle (17). The square bar segment (181) is formed on the inner end of the driving shaft (18).

The circular bar segment (182) is formed on the outer end of the driving shaft (18), is formed with the square bar segment (181) and extends through the internal hole (171) of the rotating spindle (17), the circular hole (162) of the engaging wheel (16), the connecting hole (151) of the hooking wheel (15) and the outer shaft hole (1313) of the transmitting casing (131) and has a free end and an external surface. The free end of the circular bar segment (182) extends out of the closed outer side of the transmitting casing (131). The engaging face (183) is formed on the external surface of the circular bar segment (182) in the free end, engages the connecting hole (151) of the hooking wheel (15) and extends out of the outer shaft hole (1313) of the transmitting casing (131). The annular groove (184) is formed on the external surface of the circular bar segment (182) near the free end and extends out of the outer shaft hole (1313) of the transmitting casing (131). The retaining ring (185) is mounted around the annular groove (184) and abuts with the closed outer side of the transmitting casing (131) to hold the driving shaft (18) with the transmitting casing (131).

The latch (20) is securely mounted in the sidewall of the door, is connected to the exterior assembly (10) and has a mounting end, a locking end, a latch bar (21), a rotating hole (22) and two through hole (23). The mounting end of the latch (20) is mounted securely in the sidewall of the door. The locking end of the latch (20) extends out of the sidewall of the door. The latch bar (21) is movably mounted in the locking end of the latch (20). The rotating hole (22) is formed through the latch (20) between the mounting end and the locking end and is mounted around the square bar segment (181) of the driving segment (18) to allow the latch bar (21) to retract relative to the door when the driving segment (18) is rotated. The through holes (23) are formed through the latch (20) beside the rotating hole (22) and are respectively mounted around the supporting rods (133) of the transmitting device (13) to connect the exterior assembly (10) with the latch (20).

The interior assembly (30) is securely mounted on the inner side of the door, is connected to the exterior assembly (10) and the latch (20) and has an outer side, an inner side, a rotating mount (33), an inside reset spring (31), a driving square hole (32) and a rotating button (34). The outer side of the interior assembly (30) is securely mounted on the inner side of the door and is connected to the exterior assembly (10). The inner ends of the supporting rods (133) of the transmitting device (13) extend through the through holes (23) of the latch (20) and are connected to the outer side of the interior assembly (30).

The rotating mount (33) is rotatably mounted on the outer side of the interior assembly (30) and has a periphery and a center. The inside reset spring (31) is mounted around the periphery of the rotating mount (33) to let the rotating mount (33) returning to the original position. The driving square hole (32) is formed in the center of the rotating mount (33) and is mounted around the square bar segment (181) of the driving shaft (18). The rotating button (34) is rotatably mounted on the inner side of the interior assembly (30) and is connected to the rotating mount (33) to let the driving shaft (18) rotating with the rotating button (34).

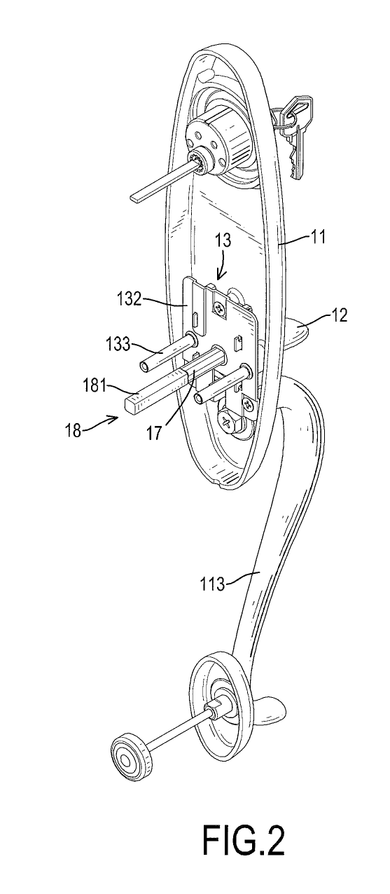

With reference to FIGS. 1 and 2, the latch (20) is mounted in the sidewall of the door and the exterior assembly (10) and the interior assembly (30) are respectively mounted on the outer side and the inner side of the door. The latch bolt (21) can be retracted into the locking end of the latch (20) when the rotating spindle (17) is rotated so as to unlock the door. The rotating spindle (17) can be rotated relative to the latch by pressing the press-button (12) of the exterior assembly (10) or rotating the rotating button (34) of the interior assembly (30) in clockwise or counterclockwise directions.

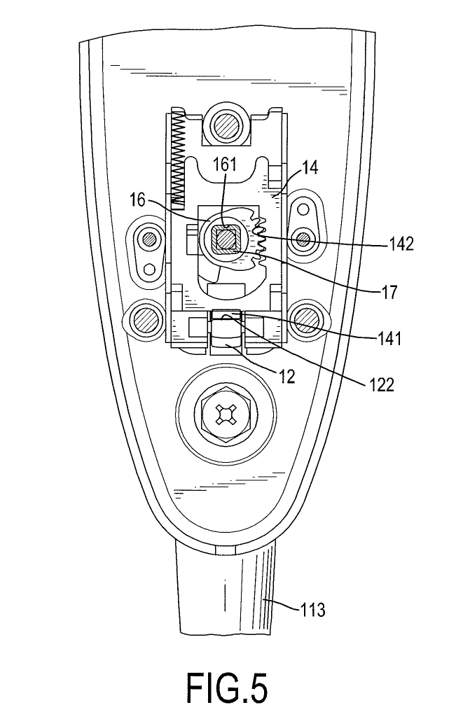

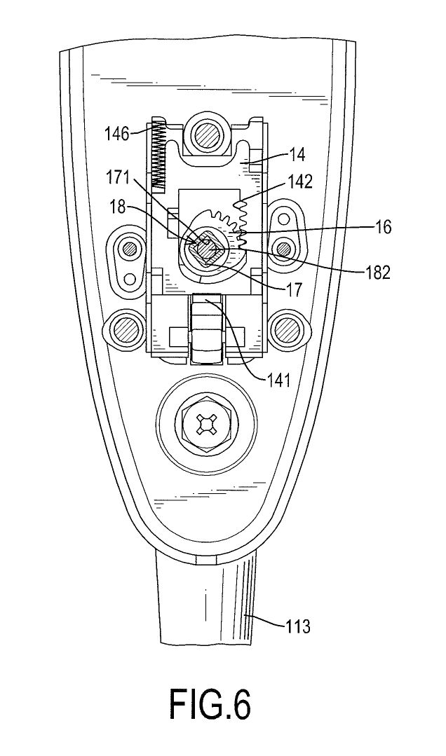

With reference to FIGS. 5 and 6, when the user presses the press-button (12) of the exterior assembly (10), the driving surface (122) on the inner end of the press-button (12) will abut the abutting slab (141) to push the transmitting board (14) moving upward relative to the engaging wheel (16). As the transmitting board (14) moves upward with the inner end of the press-button (12), the engaging wheel (16) will rotate in a counterclockwise direction as shown in FIG. 6 with the engagement between the rack (142) and the engaging teeth (163). Then, the rotating spindle (17) that connected to the spindle hole (161) will be rotated by the engaging wheel (16) to let the latch blot (21) retracting into the locking end of the latch (20) and to unlock the door. When the user releases the press-button (12), the press-button (12) and the engaging wheel (16) can be returned to the original position by the outside reset spring (146) pushes the transmitting board (14) moving back the original location.

During the operating process of unlocking the door above-mentioned, the driving shaft (18) will not rotate with the rotating spindle (17) due to the circular bar segment (182) of the driving shaft (18) being rotatably mounted in the square internal hole (171) of the rotating spindle (17). Therefore, this can prevent the inside reset spring (31) of the interior assembly (30) from being presses when the rotating spindle (17) is rotated by the press-button (12). Consequently, the useful life of the inside reset spring (31) of the interior assembly (30) will be prolonged.

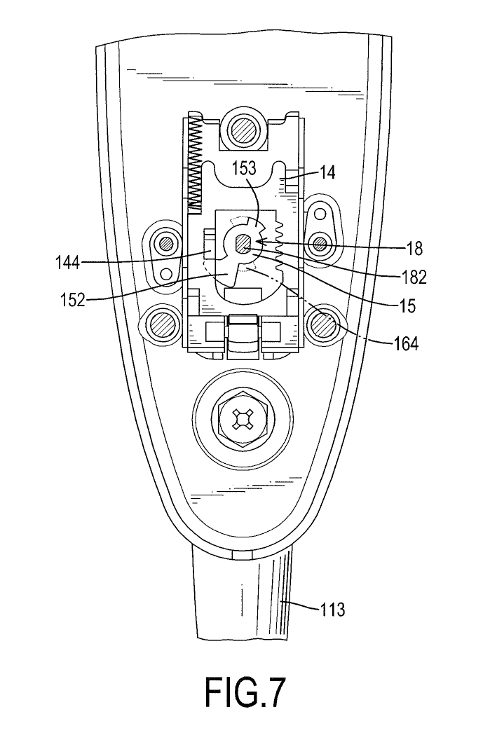

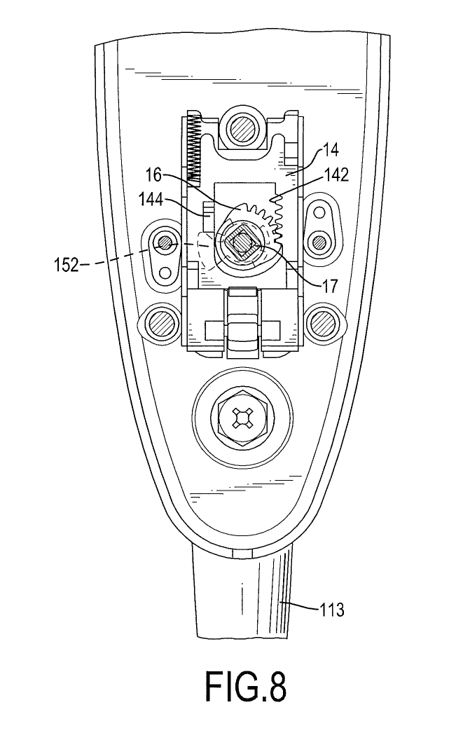

When the rotating button (34) is rotated in a clockwise direction as shown in FIGS. 7 and 8, the driving shaft (18) will be rotated in a clockwise direction with the driving hole (32) of the rotating mount (33) being securely mounted around the square bar segment (181). The hooking wheel (15) will be rotated due to the engaging face (183) of the driving shaft (18) being securely mounted in the connecting hole (151) of the hooking wheel (15). When the hooking wheel (15) rotates with the driving shaft (18), the pushing board (152) of the hooking wheel (15) will abut and push the transmitting block (144) to let the transmitting board (14) moving upward relative to the engaging wheel (16). The engaging wheel (16) will be rotated in a counterclockwise direction with the engagement between the rack (142) and the engaging teeth (163). Then, the rotating spindle (17) will be rotated with the engaging wheel (16) in a counterclockwise direction to retract the latch blot (21) into the locking end of the latch (20) and to unlock the door.

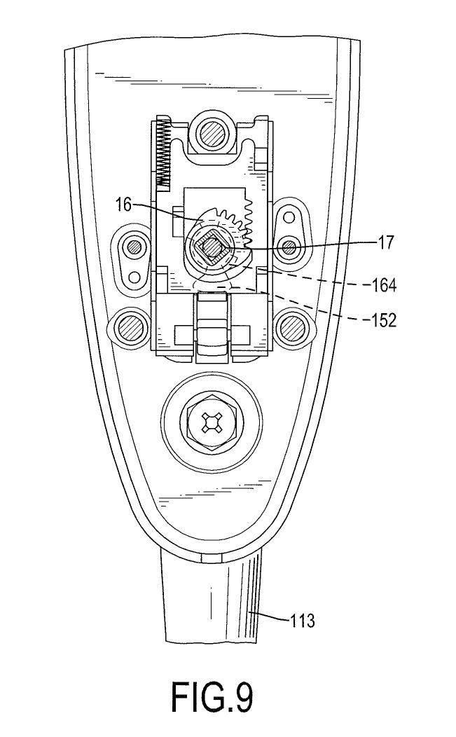

When the rotating button (34) is rotated in a counterclockwise direction as shown in FIGS. 7 and 9, the hooking wheel (15) will be rotated by the driving shaft (18), the pushing board (152) of the hooking wheel (15) will abut and push one of the limiting blocks (164) to rotate the engaging wheel (16) in a counterclockwise direction. Then, the rotating spindle (17) will be also rotated with the engaging wheel (16) in a counterclockwise direction to retract the latch blot (21) into the locking end of the latch (20) and to unlock the door.

Consequently, the door can be unlocked by pressing the press-button (12) of the exterior assembly (10) or rotating the rotating button (34) of the interior assembly (30) in clockwise or counterclockwise directions to rotate the single rotating spindle (17). Therefore, the driving shaft (18) will not be rotated with the rotating spindle (17) and the reset springs (146, 31) will not be compressed at the same time when unlocks the door. Thus, this will decrease the force for pressing the press-button (12), and the life span of the reset springs (146, 31) can be prolonged. Furthermore, when the locking assembly is applied to a door having a different thickness, the locking assembly in accordance with the present invention only needs to change a new rotating spindle (17) and it is convenient in assemble.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A locking assembly for a door having an outer side, an inner side and a sidewall and the locking assembly comprising
an exterior assembly adapted to securely mount on the outer side of the door and having
a mounting seat adapted to securely mount on the outer side of the door and having
an outer side;
an inner side adapted to abut with the outer side of the door;
an upper end;
a lower end;
a handle mounted on the outer side of the mounting seat near the lower end; and
a mounting hole being square and formed through the mounting seat near the handle;
a press-button pivotally connected to the mounting seat in the mounting hole and having
an inner end inserted in the mounting hole and extending out of the inner side of the mounting seat;
an outer end;
a top side; and
a driving surface defined on the top side of the press-button at the inner end;
a transmitting device mounted on the inner side of the mounting seat and having
a transmitting casing being rectangular, mounted on the inner side of the mounting seat and having
a closed outer side mounted on the inner side of the mounting seat;
an open inner side;
a top;
a bottom;
two opposite sidewalls;
a width;
a button through hole formed through the closed outer side and the bottom of the transmitting casing and aligning with the mounting hole, wherein the inner end of the press-button extends out of the button through hole of the transmitting casing; and
an outer shaft hole formed through the closed outer side of the transmitting casing above the button through hole and having a diameter; and
a covering panel detachably connected to the transmitting casing to cover the open inner side of the transmitting casing and having
a width being larger than the width of the transmitting casing;
a top;
a bottom, wherein the inner end of the press-button extending out the bottom of the covering panel; and
an inner shaft hole formed through the covering panel, aligning with the outer shaft hole of the transmitting casing and having a diameter larger than the diameter of the outer shaft hole;
a transmitting board mounted in the transmitting device between the transmitting casing and the covering panel and having
a top;
a bottom;
a middle;
two sides;
an abutting slab formed on and protruding from the bottom of the transmitting board, extending out of the bottom of the covering panel and abutting with the driving surface of the press-button;
a rack formed in the transmitting board near the middle and parallel with the opposite sidewalls of the transmitting casing near one of the sides of the transmitting board;
two positioning blocks respectively formed on and protruding from the top and the bottom of the transmitting board on the side that adjacent to the rack and abutting the closed outer side of the transmitting casing;
a transmitting block formed on and protruding from the middle of the transmitting board near the other side and opposite to the rack, abutting the closed outer side of the transmitting casing and having a bottom face;
a spring mount formed on the side of the transmitting board that adjacent to the transmitting block; and
an outer reset spring mounted between the transmitting casing and the transmitting board and having two ends, one of ends of the outside reset spring abutting the top of the transmitting casing and the other end of the outside reset spring mounted on the spring mount of the transmitting board;
a hooking wheel being circular, rotatably mounted in the transmitting device between the transmitting casing, the positioning blocks and the transmitting block of the transmitting board and having
a connecting hole formed through the hooking wheel and aligning with the outer shaft hole of the transmitting casing;
a pushing board formed on and protruding from the hooking wheel and abutting the bottom face of the transmitting block; and
a driven slab formed on and protruding from the hooking wheel opposite to the pushing board;
an engaging wheel rotatably mounted in the transmitting board between the hooking wheel and the covering panel, engaging the rack of the transmitting board and having
an inner side mounted in the inner shaft hole of the covering panel;
an outer side mounted in the transmitting board between the rack and the transmitting block;
a periphery;
a spindle hole being square, formed in the inner side of the engaging wheel and having a diameter;
a circular hole formed in the outer side of the engaging wheel, communicating with the spindle hole, aligning with the connecting hole of the hooking wheel and having a diameter smaller than the diameter of the spindle hole;
multiple engaging teeth formed on the periphery of the engaging wheel near the outer side and engaging the rack of the transmitting board; and
two limiting blocks formed on and protruding from the outer side of the engaging wheel beside the driven slab of the hooking wheel, wherein the driven slab of the hooking wheel selectively abutting one of the limiting blocks;
a rotating spindle being square, connected to the engaging wheel and having
an outer end mounted in the spindle hole of the engaging wheel;
an inner end extending out of the inner shaft hole of the covering panel; and
an internal hole formed through the ends of the rotating spindle and corresponding to the circular hole of the engaging wheel; and
a driving shaft rotatably mounted in the rotating spindle, extending through the rotating spindle, the covering panel, the engaging wheel, the transmitting board and the hooking wheel and securely connected to the transmitting casing and having
an outer end extending through the rotating spindle, the covering panel, the engaging wheel, the transmitting board and the hooking wheel and securely connected to the outer shaft hole of the transmitting casing;
an inner end extending out of the inner end of the rotating spindle;
a square bar segment formed on the inner end of the driving shaft;
a circular bar segment formed on the outer end of the driving shaft, formed with the square bar segment and extending through the internal hole of the rotating spindle, the circular hole of the engaging wheel, the connecting hole of the hooking wheel and the outer shaft hole of the transmitting casing and having
a free end extending out of the closed outer side of the transmitting casing; and
an external surface;
an engaging face formed on the external surface of the circular bar segment in the free end, engaging the connecting hole of the hooking wheel and extending out of the outer shaft hole of the transmitting casing;
an annular groove formed on the external surface of the circular bar segment near the free end and extending out of the outer shaft hole of the transmitting casing; and
a retaining ring mounted around the annular groove and abutting with the closed outer side of the transmitting casing to hold the driving shaft with the transmitting casing;
a latch adapted to securely mount in the sidewall of the door, connected to the exterior assembly and having
a mounting end adapted to mount securely in the sidewall of the door;
a locking end adapted to extend out of the sidewall of the door;
a latch bar movably mounted in the locking end of the latch; and
a rotating hole formed through the latch between the mounting end and the locking end and mounted around the square bar segment of the driving segment to allow the latch bar retract relative to the door when the driving segment rotated; and
an interior assembly adapted to securely mount on the inner side of the door, connected to the exterior assembly and the latch and having
an outer side adapted to securely mount on the inner side of the door and connected to the exterior assembly;
an inner side;
a rotating mount rotatably mounted on the outer side of the interior assembly and having
a periphery; and
a center;
an inside reset spring mounted around the periphery of the rotating mount to let the rotating mount returning to the original position;
a driving square hole formed in the center of the rotating mount and mounted around the square bar segment of the driving shaft; and
a rotating button rotatably mounted on the inner side of the interior assembly and connected to the rotating mount to let the driving shaft rotating with the rotating button.

2. The locking assembly as claimed in claim 1, wherein
the mounting seat has
two mounting bases formed on and protruding from the inner side of the mounting seat beside the mounting hole and each mounting base having a mounting recess faced the mounting hole; and
a mounting pin mounted in the mounting recesses of the mounting bases;
the press-button has a pin hole formed through the press-button near the inner end and mounted around the mounting pin of the mounting seat; and
the closed outer side of the transmitting casing is covered the mounting recesses of the mounting seat to hold the mounting pin between the mounting bases and the transmitting casing.

3. The locking assembly as claimed in claim 2, wherein
the transmitting casing has multiple holding claws respectively formed on and protruding from the opposite sidewalls of the transmitting casing around the open inner side;
the covering panel has
multiple holding holes formed through the covering panel and respectively connected to the holding claws of the transmitting casing to hold the covering panel securely with the transmitting casing;
multiple fastener holes formed through the covering panel near the top and the bottom; and
multiple fasteners screwed in the fastener holes and connected securely to the inner side of the mounting seat.

4. The locking assembly as claimed in claim 3, wherein
the covering panel has two positioning holes formed through the covering panel beside the inner shaft hole;
the transmitting device has two supporting rods connected to the covering panel and each supporting rod having
a diameter;
an outer end;
an inner end; and
a positioning pin formed on and protruding from the outer end of the supporting rod, mounted in one of the positioning holes of the covering panel and having a diameter smaller than the diameter of the supporting rod;
the latch has two through hole formed through the latch beside the rotating hole and respectively mounted around the supporting rods of the transmitting device to connect the exterior assembly with the latch; and
the inner ends of the supporting rods extend through the through holes of the latch and are connected to the outer side of the interior assembly.

5. The locking assembly as claimed in claim 1, wherein
the transmitting casing has multiple holding claws respectively formed on and protruding from the opposite sidewalls of the transmitting casing around the open inner side;
the covering panel has
multiple holding holes formed through the covering panel and respectively connected to the holding claws of the transmitting casing to hold the covering panel securely with the transmitting casing;
multiple fastener holes formed through the covering panel near the top and the bottom; and
multiple fasteners screwed with the fastener holes and connected securely to the inner side of the mounting seat.

6. The locking assembly as claimed in claim 1, wherein
the covering panel has two positioning holes formed through the covering panel beside the inner shaft hole;
the transmitting device has two supporting rods connected to the covering panel and each supporting rod having
a diameter;
an outer end;
a inner end; and
a positioning pin formed on and protruding from the outer end of the supporting rod, mounted in one of the positioning holes of the covering panel and having a diameter smaller than the diameter of the supporting rod;
the latch has two through hole formed through the latch beside the rotating hole and respectively mounted around the supporting rods of the transmitting device to hold the exterior assembly with the latch; and
wherein the inner ends of the supporting rods extend through the through holes of the latch and are connected to the outer side of the interior assembly.
